(19) United States
(12) Patent Application Publication
(10) Pub. No.: US 2007/0165738 A1
(43) Pub. Date: Jul. 19, 2007

(54) METHOD AND APPARATUS FOR PRE-CODING FOR A MIMO SYSTEM

(76) Inventors: Gwendolyn D. Barriac, San Diego, CA (US); Jibing Wang, San Diego, CA (US); Alexei Gorokhov, San Diego, CA (US); Hemanth Sampath, San Diego, CA (US); Tamer Kadous, San Diego, CA (US)

Correspondence Address: QUALCOMM INCORPORATED, 5775 MOREHOUSE DR., SAN DIEGO, CA, 92121, US

(21) Appl. No.: 11/552,948

(22) Filed: Oct. 25, 2006

Related U.S. Application Data
(63) Continuation of application No. 60/731,022, filed on Oct. 27, 2005.

(51) Int. Cl. H04L 1/02

(52) U.S. Cl. 375/267

(57) ABSTRACT

Systems and methodologies are described that facilitates computing a precoding index which correlates to a precoding matrix within a codebook. According to various aspects, systems and/or methods are described that facilitate computing an effective signal-to-noise ratio (SNR). Such systems and/or methods may further facilitate selecting a precoding matrix and a corresponding precoding index. Such systems and/or methods may still further facilitate employing the precoding matrix in a MIMO wireless communication system.

### CROSS-REFERENCE TO RELATED APPLICATIONS

This application claims the benefit of U.S. Provisional Patent application Ser. No. 60/731,022 entitled “A METHOD AND APPARATUS FOR PRE-CODING FOR A MIMO SYSTEM” which was filed Oct. 27, 2005. The entirety of the aforementioned application is herein incorporated by reference.

### BACKGROUND

I. Field

The following description relates generally to wireless communications, and more particularly to generating unitary matrices that can be utilized in connection with linear precoding in a wireless communication system.

II. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-accesses systems may include code division multiple access (CDMA) systems, time division multiple access (TDMA) systems, frequency division multiple access (FDMA) systems, orthogonal frequency division multiple access (OFDMA) systems, and the like.

Generally, wireless multiple-access communication systems may simultaneously support communication for multiple mobile devices. Each mobile device may communicate with one or more base stations via transmissions on forward and reverse links. The forward link (or downlink) refers to the communication link from base stations to mobile devices, and the reverse link (or uplink) refers to the communication link from mobile devices to base stations. Further, communications between mobile devices and base stations may be established via single-input single-output (SISO) systems, multiple-input single-output (MISO) systems, multiple-input multiple-output (MIMO) systems, and so forth.

MIMO systems commonly employ multiple (N_{T}) transmit antennas and multiple (N_{R}) receive antennas for data transmission. A MIMO channel formed by the N_{T} transmit and N_{R} receive antennas may be decomposed into N_{S} independent channels, which may be referred to as spatial channels, where N_{S}≦{N_{T},N_{R}}. Each of the N_{S} independent channels corresponds to a dimension. Moreover, MIMO systems may provide improved performance (e.g., increased spectral efficiency, higher throughput and/or greater reliability) if the additional dimensionalities created by the multiple transmit and received antennas are utilized.

MIMO systems may support various duplexing techniques to divide forward and reverse link communications over a common physical medium. For instance, frequency division duplex (FDD) systems may utilize disparate frequency regions for forward and reverse link communications. Further, in time division duplex (TDD) systems, forward and reverse link communications may employ a common frequency region. Various techniques can be utilized to compute a precoding index (PI) for MIMO precoding. However, calculating the precoding index (PI) employed in MIMO precoding, and in particular, per-tile feedback schemes and/or average feedback schemes, can be extremely complex.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more embodiments and corresponding disclosure thereof, various aspects are described in connection with facilitating computing a precoding index that corresponds to a matrix within a codebook associated with a wireless communication environment. In order to employ the precoding index (which can correspond to a matrix within a codebook), several simplified algorithms can be utilized for MIMO precoding. For a per-tile feedback scheme, an effective signal-to-noise ratio (SNR) can be computed for each tile and for each precoding matrix, wherein the precoding matrix with the highest effective SNR can be selected. For an average feedback scheme, an effective signal-to-noise ratio (SNR) averaged over the assignments (e.g., multiple tiles) or averaged over the whole bandwidth can be computed for each precoding matrix, wherein the precoding matrix with the highest effective SNR can be selected.

According to related aspects, a method that facilitates computing a precoding index in a wireless communication environment is described herein. The method may include utilizing a per-tile feedback scheme for MIMO precoding. Further the method may include computing an effective signal-to-noise ratio (SNR) for a precoding matrix and a tile. Further the method may include selecting the precoding matrix yielding the highest effective SNR. Still further, the method may include employing the precoding matrix and corresponding precoding index in the MIMO wireless communication environment.

According to related aspects, a method that facilitates computing a precoding index in a wireless communication environment in a wireless communication environment is described herein. The method may include utilizing an average feedback scheme for MIMO precoding. Further, the method may include computing an average effective signal-to-noise ratio (SNR) for a precoding matrix. Still further, the method may include obtaining an averaged channel covariance matrix. Further, the method may include selecting a precoding matrix from a codebook utilizing at least one of the averaged effective SNR and the averaged channel covariance matrix.

Another aspect relates to a communication apparatus that may include a memory that retains instructions related to computing a precoding index by calculating an effective SNR for at least one of a per-tile feedback scheme and an average feedback scheme. Further, a processor, coupled to memory, may be configured to evaluate the instructions to employ the precoding index utilizing at least one algorithm, the precoding index correlates to a matrix within a codebook.

Yet another aspect relates to a communication apparatus that facilitates computing a precoding index. The communication apparatus may include means for computing an effective signal-to-noise ratio (SNR). The communication apparatus may further include means for selecting a precoding matrix and a corresponding precoding index. Moreover, the communication apparatus may include means for employing the precoding matrix in a MIMO wireless communication system.

Still another aspect relates to a machine-readable medium having stored thereon machine-executable instructions for computing an effective signal-to-noise ratio (SNR), selecting a precoding matrix and a corresponding precoding index, and employing the precoding matrix in a MIMO wireless communication system.

In accordance with another aspect, in a wireless communication system, an apparatus is described herein, wherein the apparatus may include a processor. The processor may be configured to ascertain to employ at least one of a per-tile feedback scheme and an average feedback scheme. Further, the processor may be configured to select a precoding matrix and a corresponding precoding index. In addition, the processor may be configured to employ the precoding matrix in a MIMO wireless communication system.

To the accomplishment of the foregoing and related ends, the one or more embodiments comprise the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of an example communications apparatus for employment within a wireless communications environment.

FIG. 3 is an illustration of an example system that facilitates computing a precoding index in a wireless communication environment.

FIG. 4 is an illustration of a communication apparatus that can be employed to mitigate complexity involved with computing a precoding index in a MIMO wireless communication system.

FIG. 5 is an illustration of an example methodology that facilitates implementing a simplified algorithm associated with computing a precoding index in a MIMO wireless communication system.

FIG. 6 is an illustration of an example methodology that facilitates calculating a precoding index in a per-tile feedback scheme employed within a MIMO wireless communication system.

FIG. 7 is an illustration of an example methodology that facilitates calculating a precoding index in a per-tile feedback scheme employed within a MIMO wireless communication system.

FIG. 8 is an illustration of a user device that facilitates monitoring and/or providing feedback in connection with broadcast and/or multicast transmission(s).

FIG. 9 is an illustration of an example wireless network environment that can be employed in conjunction with the various systems and methods described herein.

FIG. 10 is an illustration of an example system that employs simplified algorithms for computing a precoding index for a MIMO wireless communication system.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As used in this application, the terms “module,” “device,” “apparatus,” “system,” and the like are intended to refer to a computer-related entity, either hardware, firmware, a combination of hardware and software, software, or software in execution. For example, a module may be, but is not limited to being, a process running on a processor, a processor, an object, an executable, a thread of execution, a program, and/or a computer. By way of illustration, both an application running on a computing device and the computing device can be a module. One or more module can reside within a process and/or thread of execution and a module may be localized on one computer and/or distributed between two or more computers. In addition, these modules can execute from various computer readable media having various data structures stored thereon. The modules may communicate by way of local and/or remote processes such as in accordance with a signal having one or more data packets (e.g., data from one module interacting with another module in a local system, distributed system, and/or across a network such as the Internet with other systems by way of the signal).

Furthermore, various embodiments are described herein in connection with a subscriber station. A subscriber station can also be called a system, a subscriber unit, mobile station, mobile, remote station, access point, remote terminal, access terminal, user terminal, user agent, a user device, or user equipment. A subscriber station may be a cellular telephone, a cordless telephone, a Session Initiation Protocol (SIP) phone, a wireless local loop (WLL) station, a personal digital assistant (PDA), a handheld device having wireless connection capability, computing device, or other processing device connected to a wireless modem.

Moreover, various aspects or features described herein may be implemented as a method, apparatus, or article of manufacture using standard programming and/or engineering techniques. The term “article of manufacture” as used herein is intended to encompass a computer program accessible from any computer-readable device, carrier, or media. For example, computer-readable media can include but are not limited to magnetic storage devices (e.g., hard disk, floppy disk, magnetic strips, etc.), optical disks (e.g., compact disk (CD), digital versatile disk (DVD), etc.), smart cards, and flash memory devices (e.g., EPROM, card, stick, key drive, etc.). Additionally, various storage media described herein can represent one or more devices and/or other machine-readable media for storing information. The term “machine-readable medium” can include, without being limited to, wireless channels and various other media capable of storing, containing, and/or carrying instruction(s) and/or data.

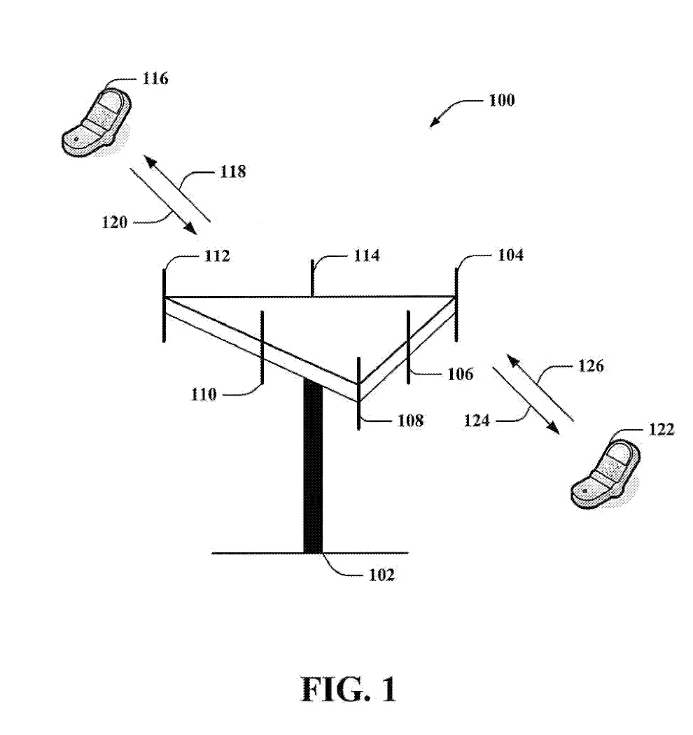

Referring now to FIG. 1, a wireless communication system 100 is illustrated in accordance with various embodiments presented herein. System 100 comprises a base station 102 that may include multiple antenna groups. For example, one antenna group may include antennas 104 and 106, another group may comprise antennas 108 and 110, and an additional group may include antennas 112 and 114. Two antennas are illustrated for each antenna group; however, more or fewer antennas may be utilized for each group. Base station 102 may additional include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 may communicate with one or more mobile devices such as mobile device 116 and mobile device 122; however, it is to be appreciated that base station 102 may communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 may utilize a different frequency band than that used by reverse link 120, and forward link 124 may employ a different frequency band than that employed by reverse link 126, for example. Further, in a time division duplex (TDD) system, forward link 118 and reverse link 120 may utilize a common frequency band and forward link 124 and reverse link 126 may utilize a common frequency band.

Each group of antennas and/or the area in which they are designated to communicate may be referred to as a sector of base station 102. For example, antenna groups may be designed to communicate to mobile devices in a sector of the areas covered by base station 102. In communication over forward links 118 and 124, the transmitting antennas of base station 102 may utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells may be subject to less interference as compared to a base station transmitting through a single antenna to all its mobile devices.

According to an example, system 100 may be a multiple-input multiple-output (MIMO) communication system. Further, system 100 may utilize any type of duplexing such as FDD, TDD, etc. Pursuant to an illustration, base station 102 may transmit over forward links 118 and 124 to mobile devices 116 and 122. Moreover, mobile devices 116 and 122 may estimate respective forward link channels and generate corresponding feedback that may be provided to base station 102 via reverse links 120 and 122. In addition, the mobile devices 116 and 122 can compute a precoding index (PI) for MIMO precoding, wherein such PI corresponds to a matrix within a codebook. Linear precoding techniques may be effectuated (e.g., by base station 102) based upon the channel related feedback; thus, subsequent transmissions over the channel may be controlled by utilizing the channel related feedback (e.g., beamforming gain may be obtained by employing linear precoding).

Pursuant to another example, the system 100 can utilize simplified algorithms to compute a precoding index (PI) for MIMO precoding assuming the code book designed is related to C={F_{f}}ⱼ₌₁^{N}. It is to be appreciated that the precoding technique can be employed based upon per-tile feedback or the average feedback. In the per-tile feedback example, the PI can be computed for each tile. Provided a channel matrix for different tiles are denoted as H_{f,1}, H_{f,2}, . . . , H_{f,M}, M can be the number of tiles in a current assignment and f is frequency. It is to be appreciated that the number of feedback bits can be saved by considering feedback for one PI for the whole assignment (e.g., the average feedback scheme).

In a per-tile feedback scheme, the effective signal-to-noise ratio (SNR) can be computed for each precoding matrix, wherein for each tile there are i-th tiles H_{f,i}. After the computation of the effective SNR, the precoding matrix with the highest effective SNR can be selected. It is to be appreciated that the effective SNR can be computed by first computing the post processing SNRs and then converting the post processing SNRs to be constrained capacity (e.g., or unconstrained capacity) with certain gap to capacity. The computation can be simplified utilizing the following metric to pick a precoding matrix:

for the i-th tile H_{f,i}, compute the following:
max [trace(Fⱼ^{H}H^{H}f,iH_{f,i}Fⱼ)]

In an average feedback scheme, the effective SNR averaged over the assignments (e.g., multiple tiles) or averaged over the whole bandwidth can be computed. In other words, the effective SNR can be averaged over at least one of the following: the following: 1) the entire assignment; 2) at least one tile of the assignment; and 3) a portion of the bandwidth that is not dependent upon the assignment. To save the computation complexity, at least one of the assignment and the whole band can be sampled to compute the effective SNR. For instance, the averaged channel covariance matrix can be obtained by averaging over the assignments or the whole band, which can yield R=E(H^{H}H). The codebook can be selected through one of the following techniques: 1) max [trace(Fⱼ^{H}RFⱼ)]; 2) max [log det(I+ρF_{f}^{H}RFⱼ)], where ρ is the average SNR; and 3) maximize the effective SNR by substituting R into the post processing SNR computation.

It is to be appreciated that for either scheme (e.g., per-tile feedback schemes and/or average feedback schemes), the complexity of an exhaustive search can be saved and/or avoided by partitioning the codebook into several subsets. For instance, the codebook can be partitioned such that the precoding matrices within one set are close to each other in the sense of certain distances (e.g., such as the Euclidian distance), while the matrices from different subsets have large distances. The metric (e.g., effective SNR) for sample matrices in the subset can be computed, wherein one or more subsets with the largest metric can be selected. The exhaustive search can be employed within the matrices within the selected subsets.

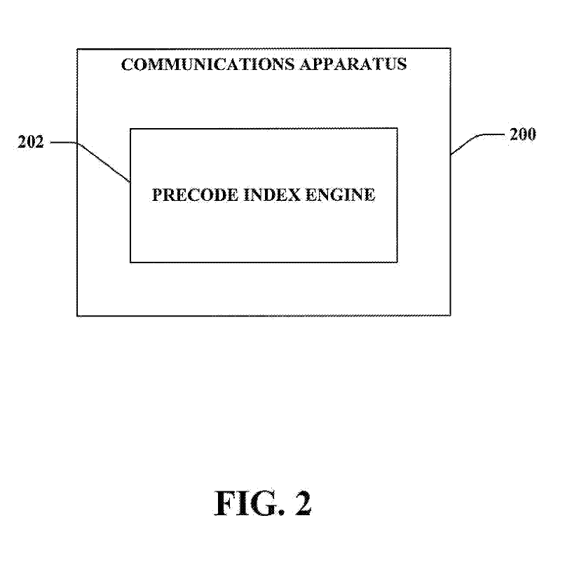

Turning to FIG. 2, illustrated is a communications apparatus 200 for employment within a wireless communications environment. Communications apparatus 200 may be a base station or a portion thereof or a mobile device or a portion thereof. Communications apparatus 200 may include a precode index engine 202 that utilizes at least one simplified algorithm to compute a precoding index (PI) for MIMO precoding, wherein such precoding index (PI) can correspond to a matrix associated with a codebook. Upon computing the precoding index for MIMO precoding, the communication apparatus 200 and a disparate communication apparatus (not shown) can have a common understanding of the calculated PI based at least in part upon the communication apparatus 200 and disparate communication apparatus implementing a common codebook. It is to be appreciated that the codebook may be substantially similar to a codebook of a disparate communications apparatus with which communications apparatus 200 interacts (e.g., for example, a mobile device can employ a common codebook with a disparate codebook associated with a base station).

Although not depicted, it is contemplated that precode index engine 202 may be separate from communications apparatus 200; according to this example, precode index engine 202 may compute the precoding index (PI) and transfer the selected PI to communications apparatus 200, which allows the selection of a specific matrix to be utilized. Pursuant to another example, communications apparatus 200 may implement a matrix within the codebook that corresponds to the PI and thereafter provide such matrix to a disparate communications apparatus; however, is it to be appreciated that the claimed subject matter is not so limited to the aforementioned examples.

By way of example, communications apparatus 200 may be a mobile device that employs at least one matrix from the codebook by leveraging the computation implemented by the precode index engine 202. According to this illustration, the mobile device may estimate a channel and utilize the unitary matrices to quantize the channel estimate. For instance, a particular unitary matrix that corresponds to the channel estimate may be selected from the set of unitary matrices and the computed precoding index that pertains to the selected unitary matrix may be transmitted to a base station (e.g., that employs a substantially similar codebook including a substantially similar set of unitary matrices).

Based on the simplified computation of the precoding index (PI), the communication apparatus 200 may employ a set of unitary matrices such as {Uₖ}ₖ₌₁^{N}, where N may be any integer. Further, N=2^{M}, where M may be a number of bits of feedback. Pursuant to an example, N may be 64 and accordingly 6 bits of feedback (e.g., associated with he precoding index) may be transferred from a receiver (e.g., mobile device) to a transmitter (e.g., base station); however, the claimed subject matter is not limited to the aforementioned example.

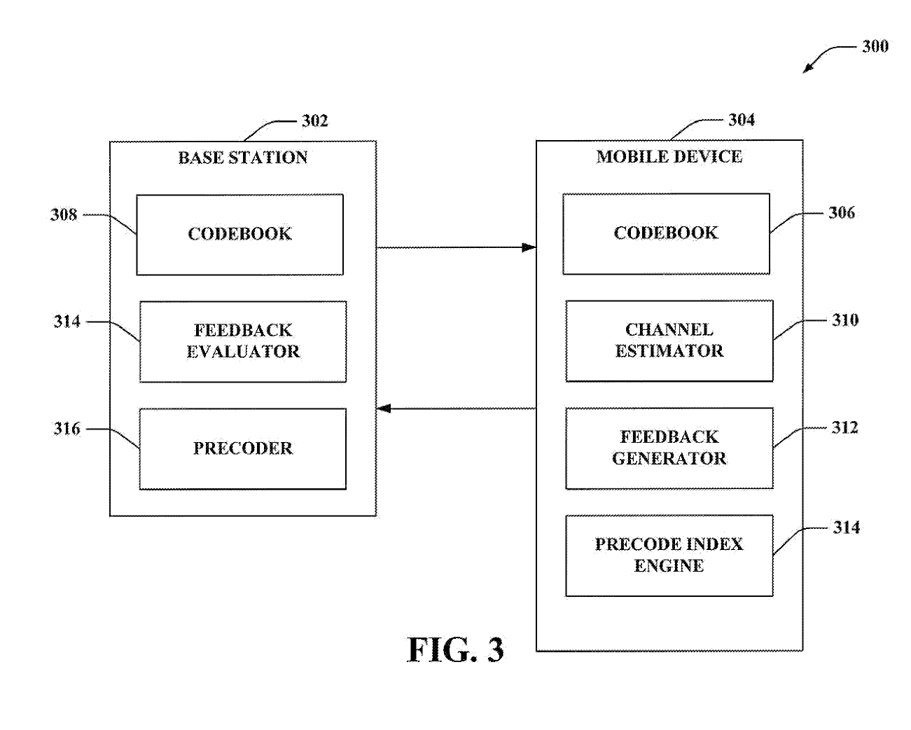

Now referring to FIG. 3, illustrated is a system 300 that facilitates computing a precoding index in a wireless communication environment. System 300 includes a base station 302 that communicates with a mobile device 304 (and/or any number of disparate mobile devices (not shown)). Base station 302 may transmit information to mobile device 304 over a forward link channel; further, base station 302 may receive information from mobile device 304 over a reverse link channel. Further, system 300 may be a MIMO system. According to an example, mobile device 304 may provide feedback related to the forward link channel via the reverse link channel, and base station 302 may utilize the feedback to control and/or modify subsequent transmission over the forward link channel (e.g., employed to facilitate beamforming).

Mobile device 304 may include a precode index engine 314 that utilizes at least one simplified algorithm to compute the precoding index (PI) that correlates to a matrix within a codebook. Accordingly, base station 302 and mobile device 304 may obtain substantially similar codebooks (depicted as codebook 306 and codebook 308) that include a common set of unitary matrices yielded by the precode index engine 314 that computes a precoding index that correlates to such matrix. Although not depicted, it is to contemplated that the precode index engine 314 can compute the PI which relates to a matrix within the codebook 306 for the mobile device 304, and such PI may be provided to base station 302, wherein the base station 302 can identify the appropriate matrix utilizing such PI, for example. However, it is to be appreciated that the claimed subject matter is not limited to the aforementioned examples.

Mobile device 304 may further include a channel estimator 310 and a feedback generator 312. Channel estimator 310 may estimate the forward link channel from base station 302 to mobile device 304. Channel estimator 310 may generate a matrix H that corresponds to the forward link channel, where columns of H may relate to transmit antennas of base station 302 and rows of H may pertain to receive antennas at mobile device 304. According to an example, base station 302 may utilize four transmit antennas and mobile device 304 may employ two receive antennas, and thus, channel estimator 310 may evaluate the forward link channel to yield a two-by-four channel matrix H (e.g., where

$$H = [ \begin{matrix}{h}_{11} & {h}_{12} & {h}_{13} & {h}_{14} \\ {h}_{21} & {h}_{22} & {h}_{23} & {h}_{24}\end{matrix} ] ) ;$$

however, it is to be appreciated that the claimed subject matter contemplates utilizing any size (e.g., any number of rows and/or columns) channel matrix H (e.g., corresponding to any number of receive and/or transmit antennas).

Feedback generator 312 may employ the channel estimate (e.g., channel matrix H) to yield feedback that may be transferred to base station 302 over the reverse link channel. For instance, the channel unitary matrix U may include information related to direction of the channel determined from the estimated channel matrix H. Eigen decomposition of the channel matrix H may be effectuated based upon H^{H}H=U^{H}ΛU, where U may be a channel unitary matrix corresponding to the channel matrix H, H^{H} may be the conjugate transpose of H, U^{H} may be the conjugate transpose of U, and Λ may be a diagonal matrix.

Moreover, feedback generator 312 may compare the channel unitary matrix U to the set of unitary matrices (e.g., to quantize the channel unitary matrix U). Further, a selection may be made from the set of unitary matrices. Upon calculation of the unitary matrix and corresponding precoding index utilizing the precode index engine 314, the feedback generator 312 can provide the index to base station 302 via the reverse link channel.

Base station 302 may further include a feedback evaluator 314 and a precoder 316. Feedback evaluator 314 may analyze the feedback (e.g., the obtained index associated with the quantized information) received from mobile device 304. For example, feedback evaluator 314 may utilize the codebook 308 of unitary matrices to identify the selected unitary matrix based upon the received precoding index; thus, the unitary matrix identified by feedback evaluator 314 may be substantially similar to the unitary matrix employed by the precode index engine 314.

Further, precoder 316 may be utilized by base station 302 to alter subsequent transmissions over the forward link channel based upon the unitary matrix identified by feedback evaluator 314. For example, precoder 316 may perform beamforming for forward link communications based upon the feedback. According to a further example, precoder 316 may multiply the identified unitary matrix by a transmit vector associated with the transmit antennas of base station 302. Further, transmission power for each transmit antenna employing a unitary matrix may be substantially similar.

According to an example, precoding and space division multiple access (SDMA) Codebooks Precoding and SDMA may be a mapping between effective antennas and tile antennas. A particular mapping may be defined by a precoding matrix. The columns of the precoding matrix may define a set of spatial beams that can be used by base station 302. Base station 302 may utilize one column of the precoding matrix in SISO transmission, and multiple columns in STTD or MIMO transmissions.

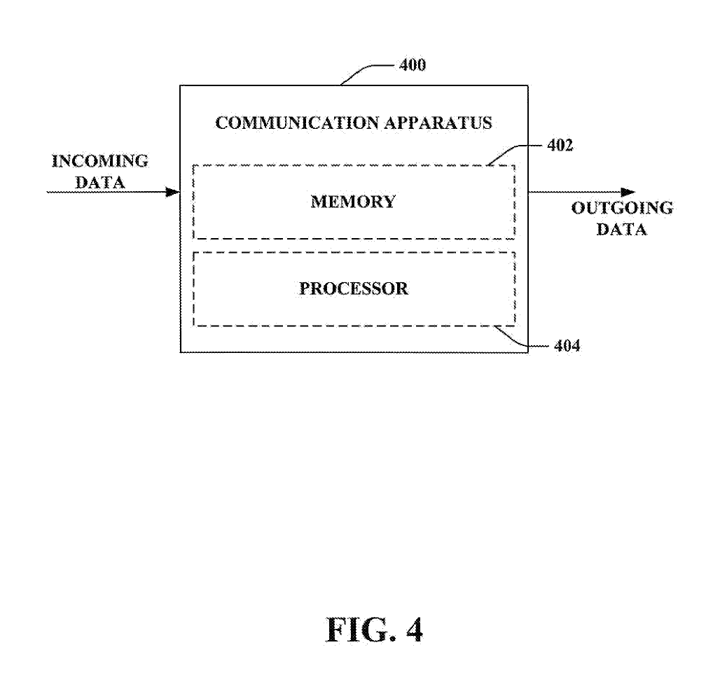

With reference to FIG. 4, illustrated is communication apparatus 400 that can be employed to mitigate complexity involved with computing a precoding index in a MIMO wireless communication system. The communication apparatus 400 can compute a precoding index that correlates to a matrix within a codebook for implementation in a MIMO wireless communication system. In particular, the communication apparatus 400 can employ algorithms that are simplified in comparison to conventional techniques. For instance, the communication apparatus 400 can compute a precoding index (PI) for MIMO precoding in a per-tile feedback scheme and an average feedback scheme. In a per-tile feedback scheme, the effective SNR for each precoding matrix can be calculated, wherein the precoding matrix with the highest effective SNR can be selected. In an average feedback scheme, an averaged effective SNR can be computed and over the assignments (e.g., multiple tiles) or over the whole bandwidth for each precoding matrix. It is to be appreciated that to save computation complexity, the assignment (e.g., or the whole band) can be sampled to compute the effective SNR. In addition, the communication apparatus 400 can include memory 402 that can retain instructions associated with computing the precoding index by calculating the effective SNR for at least one of per-tile feedback schemes and average feedback schemes. Additionally, the communication apparatus 400 can include a processor 404 that can execute such instructions within memory 402 and/or employ the precoding index with the highest effective SNR.

For example, the memory 402 can include instructions on calculating the precoding index for a per-tile feedback scheme, wherein such instructions can be executed by the processor 404 to allow for determination of a precoding matrix and corresponding precoding index with a high effective SNR. In another example, the memory 402 can include instructions on computing the precoding index for an average feedback scheme, wherein such instructions can be executed by the processor 404 to allow for determination of a precoding matrix and corresponding precoding index with a high effective SNR.

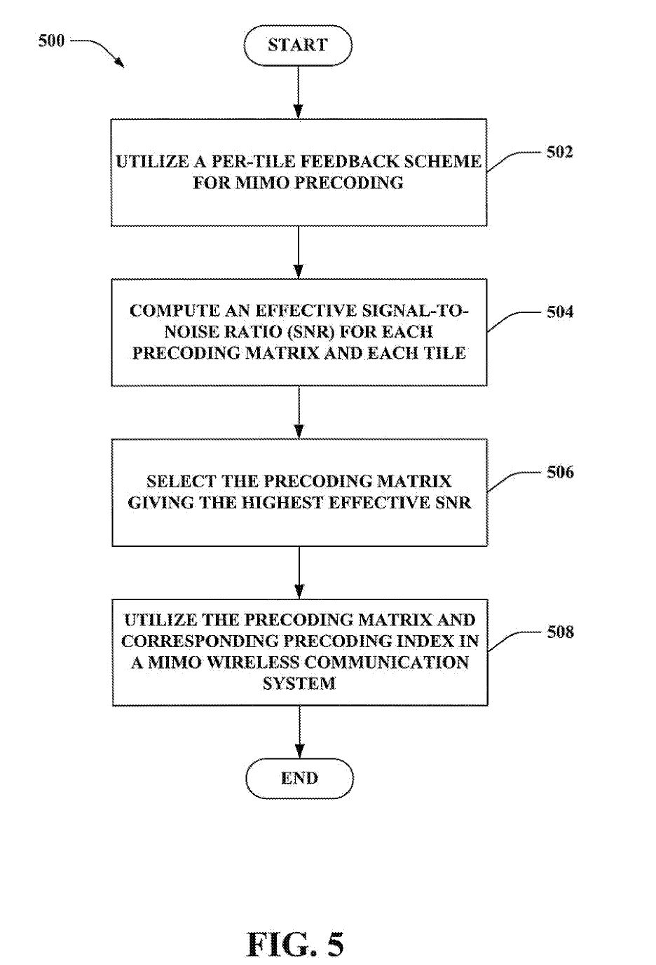

Referring to FIGS. 5-7, methodologies relating to computing a precoding index and correlating precoding matrix for MIMO systems are illustrated. While, for purposes of simplicity of explanation, the methodologies are shown and described as a series of acts, it is to be understood and appreciated that the methodologies are not limited by the order of acts, as some acts may, in accordance with one or more embodiments, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts nay be required to implement a methodology in accordance with one or more embodiments.

Now turning to FIG. 5, illustrated is a methodology 500 that facilitates implementing a simplified algorithm associated with computing a precoding index in a MIMO wireless communication system. At reference numeral 502, a per-tile feedback scheme can be utilized for MIMO precoding. The codebook for the per-tile feedback scheme can be C=[Fⱼ]ⱼ₌₁^{N}. In the per-tile feedback example, the PI can be computed for each tile. Provided a channel matrix for different tiles are denoted as H_{f,1}, H_{f,2}, . . . , H_{f,M}, M can be the number of tiles in a current assignment and f is frequency. At reference numeral 504, an effective signal-to-noise ration (SNR) can be computed for each precoding matrix and each tile. The effective SNR can be computed by first computing the post processing SNRs and then converting the post processing SNRs to constrained capacity (e.g., or unconstrained capacity) with certain gap to capacity. At reference numeral 506, the precoding matrix giving the highest effective SNR can be selected. It is to be appreciated that the computations referenced in numerals 504 and 506 can be simplified to pick precoding matrix with the following:
for the i-th tile H_{f,i}, compute max [trace(Fⱼ^{H}H^{H}f,iH_{f,i}Fⱼ)].

At reference numeral 508, the precoding matrix and corresponding precoding index can be utilized in MIMO wireless communication system.

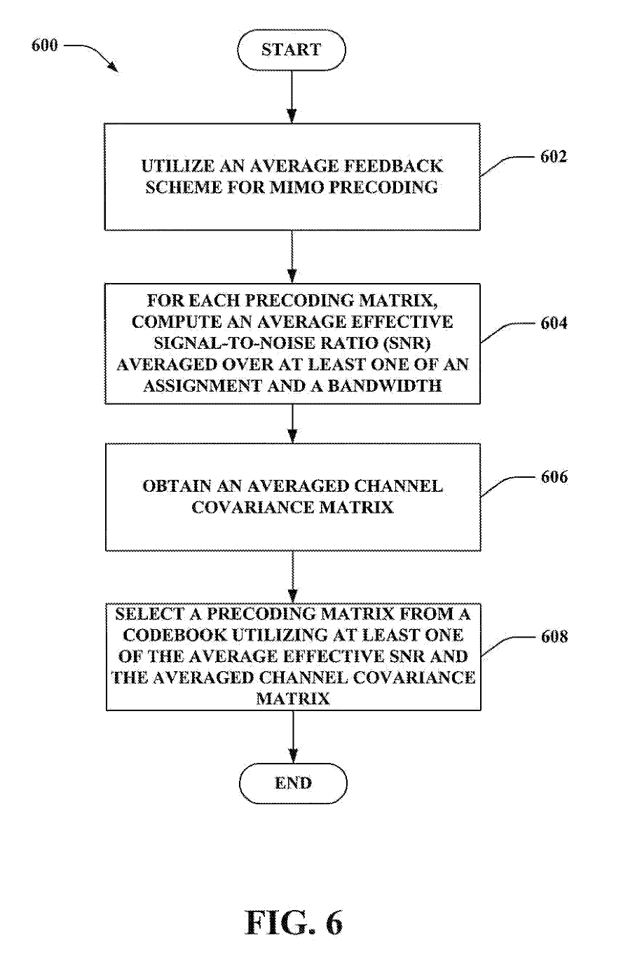

Referring to FIG. 6, illustrated is a methodology 600 that facilitates calculating a precoding index in a per-tile feedback scheme employed within a MIMO wireless communication system. At reference numeral 602, an average feedback scheme can be utilized for MIMO precoding. The codebook for the per-tile feedback scheme can be C={Fⱼ}ⱼ₌₁^{N}. Provided a channel matrix for different tiles are denoted as H_{f,1}, H_{f,2}, . . . , H_{f,M}, M can be the number of tiles in a current assignment and f is frequency. It is to be appreciated that the number of feedback bits can be saved by considering feedback for one PI for the whole assignment (e.g., the average feedback scheme). At reference numeral 604, an average effective signal-to-noise ratio (SNR) can be computed. It is to be appreciated that the average effective SNR can be averaged over the assignments (e.g., multiple tiles) and/or averaged over a whole bandwidth. The computation complexity can be reduced by sampling the assignment (e.g., or whole bandwidth) to compute the effective SNR. At reference numeral 606, an averaged channel covariance matrix can be obtained. The averaged channel covariance R=E(H^{H}H), can be obtained by averaging over the assignments or the whole band. At reference numeral 608, a precoding matrix from a codebook can be selected utilizing at least one of the average effective SNR and the averaged channel covariance matrix. The codebook can be selected through one of the following techniques: 1) max [trace(Fⱼ^{H}RFⱼ)]; 2) max [log det(I+ρFⱼ^{H}RFⱼ)], where ρ is the average SNR; and 3) maximize the effective SNR by substituting R into the post processing SNR computation.

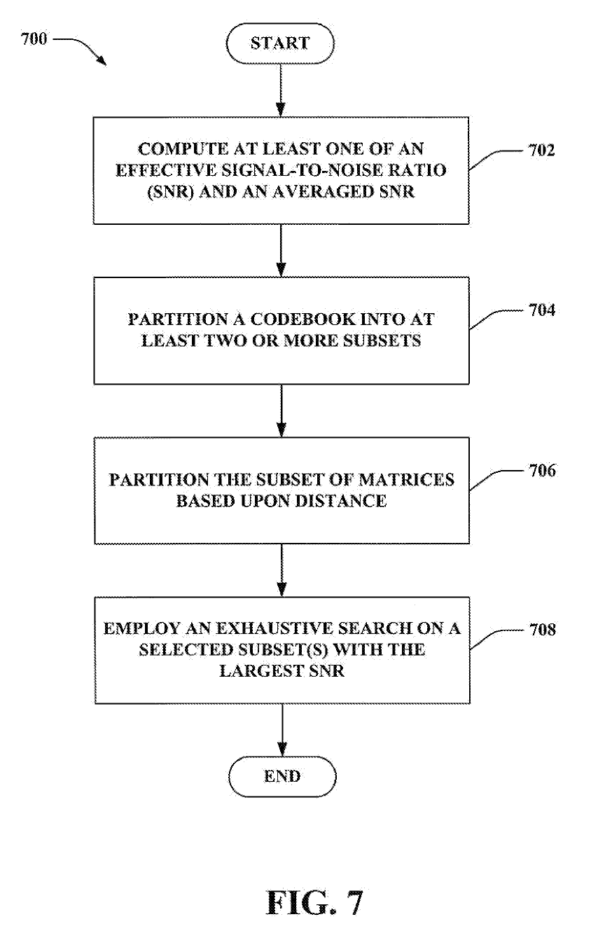

FIG. 7 is an illustration of an example methodology that facilitates calculating a precoding index in a per-tile feedback scheme employed within a MIMO wireless communication system. At reference numeral 702, at least one of an effective signal-to-noise ratio (SNR) and an averaged SNR can be computed. It is to be appreciated that a per-tile feedback scheme and/or an average feedback scheme can be employed (e.g., discussed infra). At reference numeral 704, a codebook can be partitioned into at least two or more subsets. At reference numeral 706, the subset of matrices within the codebook can be partitioned based at least in part upon a distance. For example, the Euclidian distance can be employed, wherein precoding matrices within one set are close to each other while the matrices of different subsets can have large distances. At reference numeral 708, an exhaustive search can be implemented on a selected subset(s), wherein such selected subset(s) have the largest SNR.

It will be appreciated that, in accordance with one or more aspects described herein, inferences can be made regarding calculating a precoding index (PI) for MIMO precoding, wherein such precoding index can relate to a matrix associated with a codebook that is common between at least one of a base station and a mobile device. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

According to an example, one or more methods presented above can include making inferences pertaining to computing precoding index (PI) for MIMO precoding. By way of further illustration, an inference may be made related to determining to employ a per-tile feedback scheme or an average feedback scheme. Moreover, an inference may be made in relation to determining the effective SNR for each precoding matrix within the codebook. It will be appreciated that the foregoing examples are illustrative in nature and are not intended to limit the number of inferences that can be made or the manner in which such inferences are made in conjunction with the various embodiments and/or methods described herein.

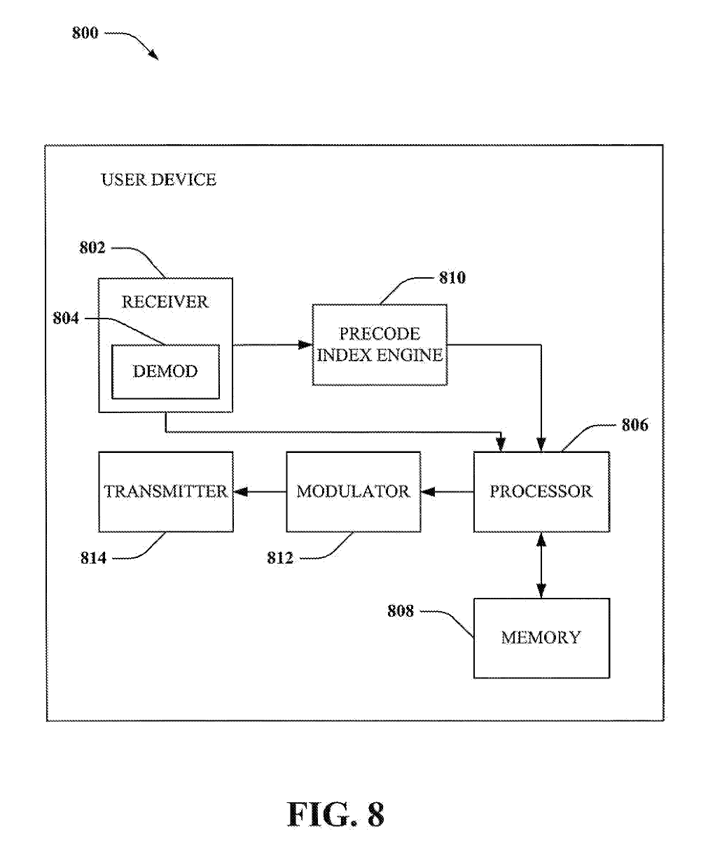

FIG. 8 is an illustration of a user device 800 (e.g., hand-held device, portable digital assistant (PDA), a cellular device, a mobile communication device, a smartphone, a messenger device, etc.) that facilitates monitoring and/or providing feedback in connection with broadcast and/or multicast transmission(s). User device 800 comprises a receiver 802 that receives a signal from, for instance, a receive antenna (not shown), and performs typical actions thereon (e.g., filters, amplifiers, downconverts, etc.) the received signal and digitizes the conditioned signal to obtain samples. Receiver 802 can be, for example, an MMSE receiver, and can comprise a demodulator 804 (also referred to as demod 804) that can demodulate received symbols and provide them to a processor 806 for channel estimation. Processor 806 can be a processor dedicated to analyzing information received by receiver 802 and/or generating information for transmission by a transmitter 814, a processor that controls one or more components of user device 800, and/or a processor that both analyzes information received by receiver 802, generates information for transmission by transmitter 814, and controls one or more components of user device 800.

User device 800 can additionally comprise memory 808 that is operatively coupled to processor 806 and that may store data to be transmitted, received data, information related to available channels, data associated with analyzed signal and/or interference strength, information related to an assigned channel, power, rate, or the like, and any other suitable information for estimating a channel and communicating via the channel. Memory 808 can additionally store protocols and/or algorithms associated with estimating and/or utilizing a channel (e.g., performance based, capacity based, etc.).

It will be appreciated that the data store (e.g., memory 808) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 808 of the subject systems and methods is intended to comprise, without being limited to, these and any other suitable types of memory. In addition, it is to be appreciated that the data store (e.g., memory 808) can be a server, a database, a hard drive, and the like.

Receiver 802 is further operatively coupled to precode index engine 810 that can facilitate computing a precoding index (PI) utilized for MIMO precoding, wherein such precoding index can correlate to a matrix within a codebook associated with at least one of a base station and a mobile device. The precode index engine 810 can compute the effective signal-to-noise ratio (SNR) for each precoding matrix and then select the precoding matrix with the highest effective SNR. For a per-tile feedback scheme, the effective SNR can be computed for each precoding matrix for each tile. For an average feedback scheme, the effective SNR can be averaged over the assignments (e.g., multiple tiles) or averaged over the entire bandwidth.

User device 800 still further comprises a modulator 812 and a transmitter 814 that transmits the signal to, for instance, a base station, another user device, a NOC, a remote agent, etc. Although depicted as being separate from the processor 806, it is to be appreciated that precode index engine 810 and/or modulator 812 may be part of processor 806 or a number of processors (not shown).

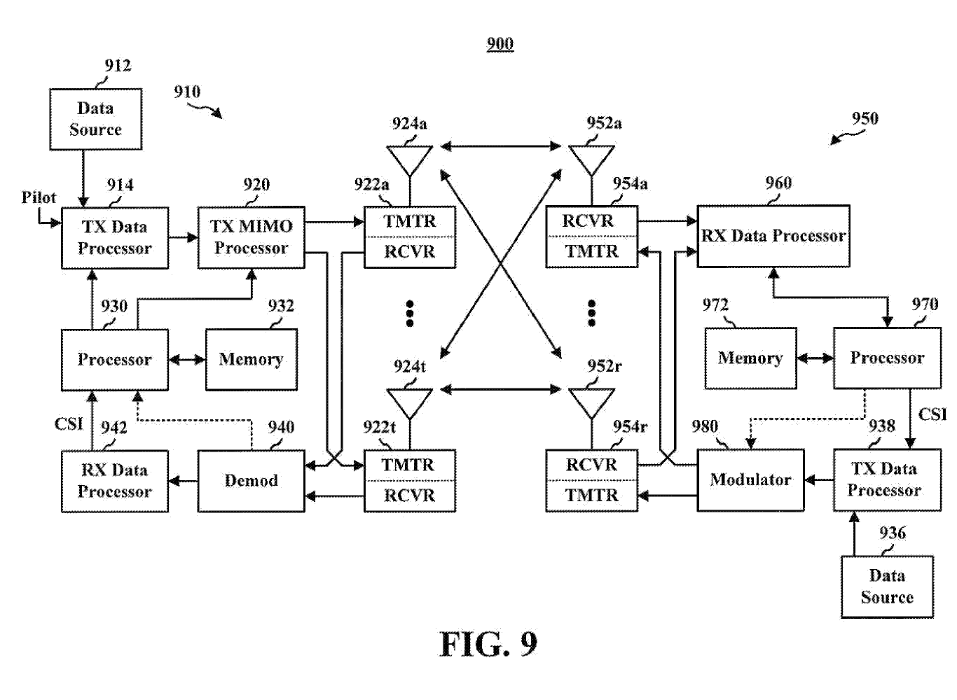

FIG. 9 shows an example wireless communication system 900. The wireless communication system 900 depicts one base station 910 and one mobile device 950 for sake of brevity. However, it is to be appreciated that system 900 may include more than one base station and/or more than one mobile device, wherein additional base stations and/or mobile devices maybe substantially similar or different from example base station 910 and mobile device 950 described below. In addition, it is to be appreciated that base station 910 and/or mobile device 950 may employ the systems (FIGS. 1-4 and 8) and/or methods (FIGS. 5-7) described herein to facilitate wireless communication there between.

At base station 910, traffic data for a number of data streams is provided from a data source 912 to a transmit (TX) data processor 914. According to an example, each data stream may be transmitted over a respective antenna. TX data processor 914 formats, codes, and interleaves the traffic data stream based on a particular coding scheme selected for that data stream to provide coded data.

The coded data for each data stream may be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and may be used at mobile device 950 to estimate channel response. The multiplexed pilot and coded data for each data stream may be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream may be determined by instructions performed or provided by processor 930.

The modulation symbols for the data streams may be provided to a TX MIMO processor 920, which may further process the modulation symbols (e.g., for OFDM). TX MIMO processor 920 then provides N_{T} modulation symbol streams to N_{T} transmitters (TMTR) 922a through 922t. In various embodiments, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g., amplifiers, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 may receive and process the N_{R} received symbol streams from N_{R} receivers 954 based on a particular receiver processing technique to provide N_{T} “detected” symbol streams. RX data processor 960 may demodulate, deinterleave, and decode each detected symbol stream to recover the traffic data for the data stream. The processing by RX data processor 960 is complementary to that performed by TX MIMO processor 920 and TX data processor 914 at base station 910.

A processor 970 may periodically determine which precoding matrix to utilize as discussed above. Further, processor 970 may formulate a reverse link message comprising a matrix index portion and a rank value portion.

The reverse link message may comprise various types of information regarding the communication link and/or the received data stream. The reverse link message may be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 may process the extracted message to determine which precoding matrix to use for determining the beamforming weights.

Processors 930 and 970 may direct (e.g., control, coordinate, manage, etc.) operation at base station 910 and mobile device 950, respectively. Respective processors 930 and 970 can be associated with memory 932 and 972 that store program codes and data. Processors 930 and 970 can also perform computations to derive frequency and impulse response estimates for the uplink and downlink, respectively.

It is to be understood that the embodiments described herein may be implemented in hardware, software, firmware, middleware, microcode, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the embodiments are implemented in software, firmware, middleware or microcode, program code or code segments, they may be stored in a machine-readable medium, such as a storage component. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, etc.

For a software implementation, the techniques described herein may be implemented with modules (e.g., procedures, functions, and so on) that perform the functions described herein. The software codes may be stored in memory units and executed by processors. The memory unit may be implemented within the processor or external to the processor, in which case it can be communicatively coupled to the processor via various means as is known in the art.

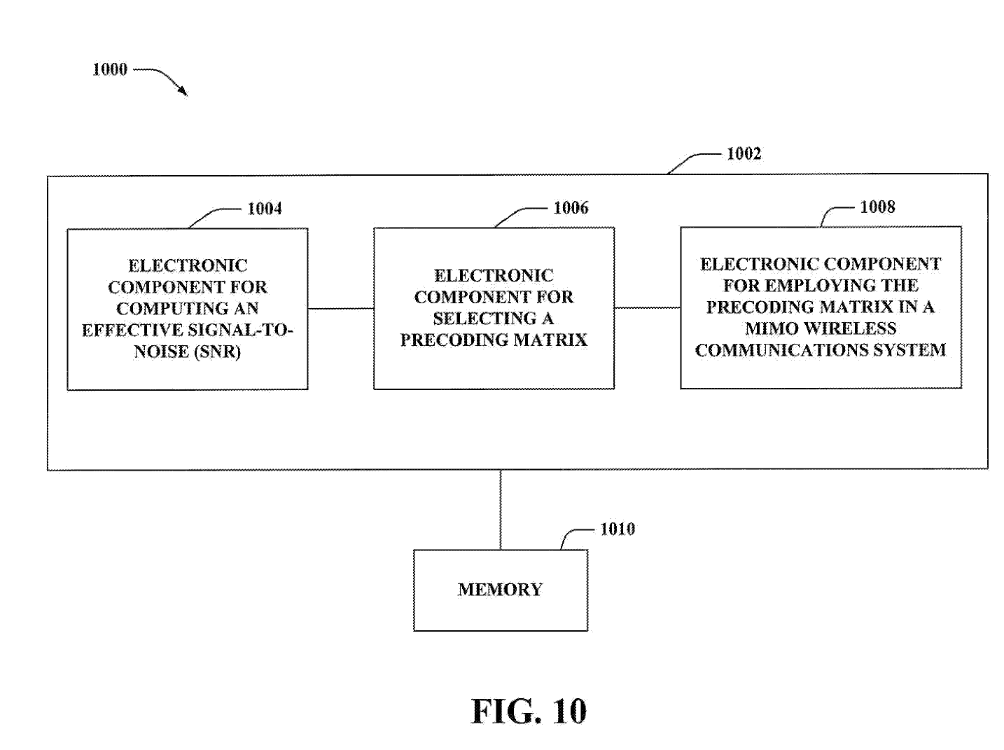

With reference to FIG. 10, illustrated is a system 1000 that employs simplified algorithms for computing a precoding index for a MIMO wireless communication system. It is to be appreciated that system 1000 is represented as including functional blocks, which may be functional blocks that represent functions implemented by a processor, software, or combination thereof (e.g., firmware). For example, the system 1000 may be implemented in a mobile device. System 1000 includes a logical grouping 1002 of electrical components that can act in conjunction to indicate that a measurement gap is desired. For instance, the grouping 1002, can include an electrical component 1004 for computing an effective signal-to-noise ratio (SNR). For example, for a per-tile feedback scheme, the effective SNR can be computed for each tile for each precoding matrix. For an average feedback scheme, the average effective SNR can be calculated by averaging over the assignments (e.g., multiple tiles) or averaged over the entire bandwidth.

Grouping 1002 can additionally include an electrical component 1006 for selecting a precoding matrix. For example, the precoding matrix with the highest signal-to-noise ratio (SNR) can be selected. Grouping 1002 can further include an electrical component 1008 for employing the precoding matrix in a MIMO wireless communications system. Additionally, system 1000 can include a memory 1010 that retains instructions for executing functions associated with the electrical components 1004, 1006, and 1008. While shown as being external to memory 1010, it is to be understood that the electrical components 1004, 1006, and 1008 can exist within memory 1010.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method that facilitates computing a precoding index in a wireless communication environment, comprising:
utilizing a per-tile feedback scheme for MIMO precoding;
computing an effective signal-to-noise ratio (SNR) for a precoding matrix and a tile;
selecting the precoding matrix yielding the highest effective SNR; and
employing the precoding matrix and corresponding precoding index in the MIMO wireless communication environment.

2. The method of claim 1, further comprising a codebook related to C={Fⱼ}ⱼ₌₁^{N}, where C denotes the codebook, Fⱼ is a matrix within the codebook, and N is an integer of matrices included within the codebook.

3. The method of claim 1, further comprising calculating the precoding index for each tile within the per-tile feedback scheme.

4. The method of claim 3, further comprising a channel matrix that denotes disparate tiles as H_{f,1}, H_{f,2}, . . . , H_{f,M}, where M is a number of tiles in a current assignment and f represents frequency.

5. The method of claim 4, further comprising employing the following metric to select the precoding matrix:
for the i-th tile H_{f,i}, compute max [trace (Fⱼ^{H}H^{H}f,iH_{f,i}Fⱼ)].

6. The method of claim 1, further comprising:
computing a post processing SNR; and
converting the post processing SNR to at least one of a constrained capacity with a gap to capacity and an unconstrained capacity with a gap to capacity.

7. The method of claim 1, further comprising:
partitioning a codebook into at least two or more subsets;
partitioning the subset of matrices based at least in part upon distance; and
employing an exhaustive search on a selected subset with the largest signal-to-noise ratio (SNR).

8. A method that facilitates computing a precoding index in a wireless communication environment, comprising:
utilizing an average feedback scheme for MIMO precoding;
computing an average effective signal-to-noise ratio (SNR) for a precoding matrix;
obtaining an averaged channel covariance matrix; and
selecting a precoding matrix from a codebook utilizing at least one of the averaged effective SNR and the averaged channel covariance matrix.

9. The method of claim 8, further comprising a codebook related to C={Fⱼ}ⱼ₌₁^{N}, where C denotes the codebook, Fⱼ is a matrix within the codebook, and N is an integer of matrices included within the codebook.

10. The method of claim 8, further comprising computing the average effective signal-to-noise ratio (SNR) that is averaged over at least one of the following: 1) the entire assignment; 2) at least one tile of the assignment; and 3) a portion of the bandwidth that is not dependent upon the assignment.

11. The method of claim 8, further comprising sampling at least one of a tile of the assignment and the entire bandwidth to compute the effective SNR.

12. The method of claim 8, further comprising utilizing the following to compute the averaged channel covariance matrix:
R=E(H^{H}H), where R is the averaged channel covariance matrix.

13. The method of claim 12, further comprising selecting the codebook with at least one of the following: 1) max [trace(Fⱼ^{H}RFⱼ)]; 2) max [log det(I+ρFⱼ^{H}RFⱼ)], where ρ is the average SNR; and 3) maximize the effective SNR by substituting R into a post processing SNR computation.

14. The method of claim 8, further comprising:
partitioning the codebook into at least two or more subsets;
partitioning the subset of matrices based at least in part upon distance; and
employing an exhaustive search on a selected subset with the largest signal-to-noise ratio (SNR).

15. A communication apparatus, comprising:
a memory that retains instructions related to computing a precoding index by calculating an effective SNR for at least one of a per-tile feedback scheme and an average feedback scheme; and
a processor, coupled to memory, configured to evaluate the instructions to employ the precoding index utilizing at least one algorithm, the precoding index correlates to a matrix within a codebook.

16. The communication apparatus of claim 15, further comprising the codebook is related to C={Fⱼ}ⱼ₌₁^{N}, where C denotes the codebook, Fⱼ is a matrix within the codebook, and N is an integer of matrices included within the codebook.

17. The communication apparatus of claim 16, further comprising calculating the precoding index for each tile within the per-tile feedback scheme.

18. The communication apparatus of claim 17, further comprising a channel matrix that denotes disparate tiles as H_{f,1}, H_{f,2}, . . . , H_{f,M}, where M is a number of tiles in a current assignment.

19. The communication apparatus of claim 18, further comprising employing the following metric to select the precoding matrix:
for the i-th tile H_{f,i}, compute max [trace(Fⱼ^{H}H^{H}f,iH_{f,i}Fⱼ)].

20. The communication apparatus of claim 19, further comprising:
computing a post processing SNR; and
converting the post processing SNR to at least one of a constrained capacity with a gap to capacity and an unconstrained capacity with a gap to capacity

21. The communication apparatus of claim 20, further comprising computing the average effective signal-to-noise ratio (SNR) that is averaged over at least one of the following: 1) the entire assignment; 2) at least one tile of the assignment; and 3) a portion of the bandwidth that is not dependent upon the assignment.

22. The communication apparatus of claim 21, further comprising sampling at least one of a tile of the assignment and the entire bandwidth to compute the effective SNR.

23. The communication apparatus of claim 22, further comprising utilizing the following to compute the averaged channel covariance matrix:
R=E(H^{H}H), where R is the averaged channel covariance matrix.

24. The communication apparatus of claim 23, further comprising selecting the codebook with at least one of the following: 1) max [trace(Fⱼ^{H}RFⱼ)]; 2) max [log det (I+ρFⱼ^{H}RFⱼ)], where ρ is the average SNR; and 3) maximize the effective SNR by substituting R into a post processing SNR computation.

25. The communication apparatus of claim 15, further comprising
partitioning the codebook into at least two or more subsets;
partitioning the subset of matrices based at least in part upon distance; and
employing an exhaustive search on a selected subset with the largest signal-to-noise ratio (SNR).

26. A communication apparatus that facilitates computing a precoding index, comprising:
means for computing an effective signal-to-noise ratio (SNR);
means for selecting a precoding matrix and a corresponding precoding index; and
means for employing the precoding matrix in a MIMO wireless communication system.

27. The communication apparatus of claim 26, further comprising means for computing the average effective signal-to-noise ratio (SNR) that is averaged over at least one of the following: 1) the entire assignment; 2) at least one tile of the assignment; and 3) a portion of the bandwidth that is not dependent upon the assignment.

28. The communication apparatus of claim 27, further comprising means for sampling at least one of a tile of the assignment and the entire bandwidth to compute the effective SNR.

29. The communication apparatus of claim 28, further comprising means for calculating an averaged channel covariance matrix with the following:
R=E(H^{H}H), where R is the averaged channel covariance matrix.

30. The communication apparatus of claim 29, further comprising means for selecting a codebook with at least one of the following: 1) max [trace(Fⱼ^{H}RFⱼ)]; 2) max [log det (I+ρFⱼ^{H}RFⱼ)], where ρ is the average SNR; and 3) maximize the effective SNR by substituting R into a post processing SNR computation.

31. The communication apparatus of claim 26, further comprising a codebook that is related to C={Fⱼ}ⱼ₌₁^{N}, where C denotes the codebook, Fⱼ is a matrix within the codebook, and N is an integer of matrices included within the codebook.

32. The communication apparatus of claim 31, further comprising means for calculating the precoding index for each tile within a per-tile feedback scheme.

33. The communication apparatus of claim 32, further comprising a channel matrix that denotes disparate tiles as H_{f,1}, H_{f,2}, . . . , H_{f,M}, where M is a number of tiles in a current assignment.

34. The communication apparatus of claim 33, further comprising means for employing the following metric to select the precoding matrix:
for the i-th tile H_{f,i}, computer max [trace(Fⱼ^{H}H^{H}f,iH_{f,i}Fⱼ)].

35. The communication apparatus of claim 26, further comprising:
means for partitioning a codebook into at least two or more subsets;
means for partitioning the subset of matrices based at least in part upon distance; and
means for employing an exhaustive search on a selected subset with the largest signal-to-noise ratio (SNR).

36. A machine-readable medium having stored thereon machine-executable instructions for:
computing an effective signal-to-noise ratio (SNR);
selecting a precoding matrix and a corresponding precoding index; and
employing the precoding matrix in a MIMO wireless communication system.

37. The machine-readable medium of claim 36, further comprising computing an average effective signal-to-noise ratio (SNR) that is averaged over at least one of the following: 1) the entire assignment; 2) at least one tile of the assignment; and 3) a portion of the bandwidth that is not dependent upon the assignment.

38. The machine-readable medium of claim 37, further comprising sampling at least one of a tile of the assignment and the entire bandwidth to compute the effective SNR.

39. The machine-readable medium of claim 38, further comprising calculating an averaged channel covariance matrix with the following:
R=E(H^{H}H), where R is the averaged channel covariance matrix.

40. The machine-readable medium of claim 39, further comprising selecting a codebook with at least one of the following: 1) max [trace(Fⱼ^{H}RFⱼ)]; 2) max [log det(I+ρFⱼ^{H}RFⱼ)], where ρ is the average SNR; and 3) maximize the effective SNR by substituting R into a post processing SNR computation.

41. The machine-readable medium of claim 36, further comprising a codebook that is related to C={Fⱼ}ⱼ₌₁^{N}, where C denotes the codebook, Fⱼ is a matrix within the codebook, and N is an integer of matrices included within the codebook.

42. The machine-readable medium of claim 41, further comprising calculating the precoding index for each tile within a per-tile feedback scheme.

43. The machine-readable medium of claim 42, further comprising a channel matrix that denotes disparate tiles as H_{f,1}, H_{f,2}, . . . , H_{f,M}, where M is a number of tiles in a current assignment.

44. The machine-readable medium of claim 43, further comprising employing the following metric to select the precoding matrix:
for the i-th tile H_{f,i}, compute max [trace(Fⱼ^{H}H^{H}f,iH_{f,i}Fⱼ)].

45. In a wireless communication system, an apparatus, comprising:
a processor configured to:
ascertain to employ at least one of a per-tile feedback scheme and an average feedback scheme;
select a precoding matrix and a corresponding precoding index; and
employ the precoding matrix in a MIMO wireless communication system.
